(19) United States
(12) Patent Application Publication
(10) Pub. No.: US 2015/0192972 A1
(43) Pub. Date: Jul. 9, 2015

(54) ELECTRIC DEVICE

(71) Applicant: Sharp Kabushiki Kaisha, Osaka (JP)

(72) Inventor: Tatsuaki Amemura, Osaka (JP)

(21) Appl. No.: 14/402,964

(22) PCT Filed: May 15, 2013
(86) PCT No.: PCT/JP2013/063524

§ 371 Date: Nov. 21, 2014

(30) Foreign Application Priority Data
May 31, 2012 (JP) 2012-125384

(51) Int. Cl. G06F 1/26

(52) U.S. Cl. CPC G06F 1/26

(57) ABSTRACT

An electric device includes a main power switch connected to a regular power supply, a sub power switch which receives a starting/stopping instruction from a user when the main power switch is turned on, and a control unit which acquires a notification signal notifying that the instruction has been received from the sub power switch and controls the starting/stopping based on the notification signal. The electric device includes a transfer unit which, when the notification signal is received from the sub power switch, transfers the fact thereof to the control unit, and the transfer unit is configured, when receiving a permission signal that the transfer is permitted from the control unit, to transmit the notification signal to the control unit.

### CROSS-REFERENCE TO RELATED APPLICATIONS

This application is a National Phase application filed under 35 USC 371 of PCT International Application No. PCT/JP2013/063524 with an International Filing Date of May 15, 2013, which claims under 35 U.S.C. §119(a) the benefit of Japanese Application No. 2012-125384, filed May 31, 2012, the entire contents of which are incorporated herein by reference.

### BACKGROUND

1. Technical Field

The present invention relates to an electric device including a main power switch connected to a regular power supply, and a sub power switch which receives a starting/stopping instruction from a user.

2. Description of the Related Art

Recently, many electric devices represented by a personal computer are provided with a sub power switch (a power button) to start the electric device separately from a main power switch for supplying DC power thereto.

Meanwhile, hardware keys often have other functions besides original functions thereof. For example, the power button not only functions as a start switch, but also serves as a trigger for shutdown or returning to a power conserving state, and has also a forced shutdown function by a prolonged pressing of the same in the personal computer.

For such a hardware key, for example, Japanese Patent Laid-open Publication No. H10-11179 discloses a personal computer, when an input operation by a keyboard is interrupted over a prescribed period, a counting unit outputs a signal, and during when the counting unit outputs the signal, a power controller for a display device blocks power to be supplied to the display device from a main body power supply. Meanwhile, when a power switch is pressed, a determination unit determines whether the counting unit outputs a signal, and only when the counting unit does not output a signal, transmits a signal indicating the fact that the power switch is pressed to the main body power supply. Thereby, since a press of the power switch is invalidated in the state that a power supply to the display device is blocked by the power controller for a display device, it is possible to prevent the power supply from being turned off by mistake instead of turning on the power supply, for example.

In addition, Japanese Patent Laid-open Publication No. 2000-125478 discloses a power device configured in such a manner that when a system power supply is turned on, a control circuit detects an operation of a power switch to control the power supply of a system power supply circuit, while when the system power supply is turned off, the operation of the power switch is not received by the control unit, so that the power supply being turned on by the erroneous operation of the power supply switch is prevented.

Further, Japanese Patent Laid-open Publication No. 2000-132259 discloses an electronic device which is provided with a suspend/resume signal generation unit which generates a suspend/resume signal that becomes a low level when a suspend/resume button is pressed between the suspend/resume button and a chip set which realizes a suspend/resume function by pressing the suspend/resume button, and limits a low level period of the suspend/resume signal generated by the suspend/resume signal generation unit to less than a prescribed period, such that malfunction due to a continuous operation or a prolonged pressing of the suspend/resume button, etc., may be prevented.

### SUMMARY

Meanwhile, as described above, the power button often performs a plurality of functions by an operation method. Therefore, in electronic devices installed in a station building, a library, a convenience store, or the like, when the power button is released so that a user or a store clerk can freely operate the same, it is exposed to an erroneous operation or a malicious operation, which may be a cause of a failure of the electric device.

However, the above-described problems may not be solved by the personal computer of Japanese Patent Laid-open Publication No. H10-11179, the power device of Japanese Patent Laid-open Publication No. 2000-125478, and the electronic device of Japanese Patent Laid-open Publication No. 2000-132259.

In consideration of the above-described circumstances, it is an object of the present invention to provide an electric device including a main power switch connected to a regular power supply, a sub power switch which receives a starting/stopping instruction from a user when the main power switch is turned on, and a control unit which acquires a notification signal notifying a fact that the instruction has been received from the sub power switch and controls the starting/stopping based on the notification signal, wherein the electric device includes a transfer unit which, when the notification signal is received from the sub power switch, transfers the fact thereof to the control unit, and the transfer unit is configured, when receiving a permission signal of the fact that the transfer is permitted from the control unit, to transmit the notification signal to the control unit, thereby a timing in which an operation of the sub power switch is validated may be limited to a specific condition, and therefore, an erroneous operation by a user or a failure caused by an operation of a malicious person may be prevented.

According to the present invention, there is provided an electric device including a main power switch connected to a regular power supply, a sub power switch which receives a starting/stopping instruction from a user when the main power switch is turned on, and a control unit which acquires a notification signal notifying a fact that the instruction has been received from the sub power switch and controls the starting/stopping based on the notification signal, the electric device including: a transfer unit which is disposed between the sub power switch and the control unit, and is configured, when the notification signal is received from the sub power switch, to transfer a fact of reception of the notification signal to the control unit, wherein the control unit transmits a permission signal of a fact that the transfer by the transfer unit is permitted to the transfer unit, and when receiving the permission signal, the transfer unit transfers the fact of reception of the notification signal to the control unit.

According to the present invention, for example, in the case in which the sub power switch is pressed by the user and the transfer unit receives the notification signal from the sub power switch, when receiving the permission signal from the control unit, the fact that the notification signal has been received is transmitted to the control unit, while when not receiving the permission signal from the control unit, the fact that the notification signal has been received is not transmitted to the control unit.

In the electric device according to the present invention, when the main power switch is turned on, the control unit is configured to transmit the permission signal to the transfer unit until the sub power switch is turned on.

According to the present invention, for example, when the main power switch is turned on, the control unit transmits the permission signal to the transfer unit until the sub power switch is turned on, in other words, until the notification signal is first received, and the control unit stops the transfer of the permission signal after the sub power switch is turned on, that is, after a first notification signal is received.

The electric device according to the present invention includes a display control unit which displays a setting screen for receiving an instruction relating to an initial setting at startup, wherein the control unit is configured to transmit the permission signal to the transfer unit while the setting screen is displayed.

According to the present invention, for example, after the main power switch is turned on, when the instruction relating to the display of the setting screen is received from an worker and the display control unit displays the setting screen thereon, the control unit transmits the permission signal to the transfer unit, and when the display of the setting screen by the display control unit is ended, the control unit stops the transfer of the permission signal.

The electric device according to the present invention includes an instruction reception unit which receives an instruction for performing functions of the electric device, wherein the transfer unit is configured, when the instruction reception unit receives the instruction and the sub power switch receives the starting/stopping instruction from a user, to transfer the fact of reception of the notification signal to the control unit.

According to the present invention, for example, if the instruction reception unit is a menu button which receives an instruction for displaying an initial screen, when the menu button receives the instruction, that is, in the case in which the menu button is being pressed, when the sub power switch receives the instruction from the user, in other words, when the menu button and the sub power switch are pressed at the same time, the transfer unit transfers of reception of the notification signal to the control unit.

According to the present invention, the operation of the sub power switch is limited and, only when the specific condition is satisfied, the operation of the sub power switch is validated. Therefore, even if the sub power switch is released to the user or the store clerk, it is possible to prevent an erroneous operation by the user or a failure caused by an operation of a malicious person.

The above and further objects and features will move fully be apparent from the following detailed description with accompanying drawings.

### BRIEF DESCRIPTION OF THE DRAWINGS

FIG. 1 is a functional block diagram illustrating a configuration of main components of a multi-function peripheral according to an embodiment of the present invention.

FIG. 2 is a block diagram describing a relation between an operation panel and a control unit in the multi-function peripheral according to the embodiment of the present invention.

FIG. 3 is a diagram describing in detail the relation between the operation panel and the control unit in the multi-function peripheral according to the embodiment of the present invention.

FIG. 4 is a flow chart illustrating an example of an instruction reception through a sub power switch in the multi-function peripheral according to the embodiment of the present invention.

FIG. 5 is a flow chart illustrating another example of the instruction reception through the sub power switch in the multi-function peripheral according to the embodiment of the present invention.

### DETAILED DESCRIPTION

Hereinafter, a case in which an electric device according to an embodiment of the present invention is applied to a multi-function peripheral will be described in detail, by way of example, with reference to the accompanying drawings. The multi-function peripheral has a function of a scanner, a facsimile, a printer and the like.

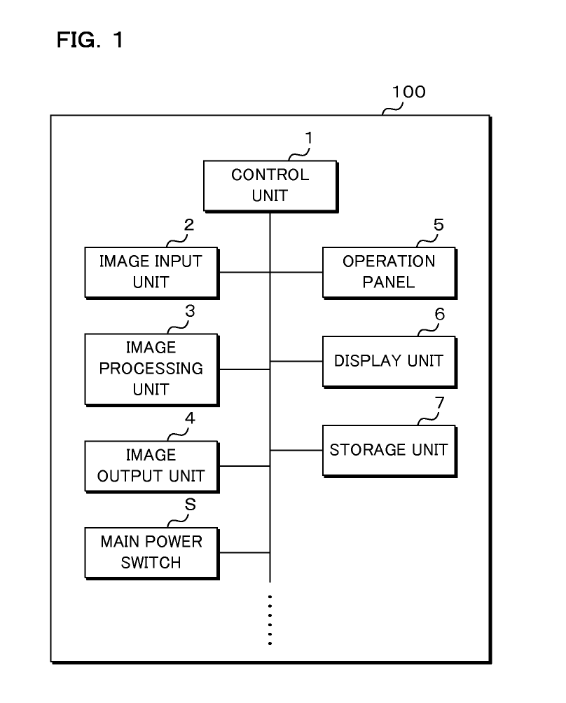

FIG. 1 is a functional block diagram illustrating a configuration of main components of a multi-function peripheral 100 according to an embodiment of the present invention. The multi-function peripheral 100 is connected to an external regular power supply through a main power switch S. In addition, the multi-function peripheral 100 includes a control unit 1, an image input unit 2, an image processing unit 3, an image output unit 4, an operation panel 5, a display unit 6, a storage unit 7 and the like.

The image input unit 2 includes a light source irradiating light to a manuscript for reading, an image sensor such as a charge coupled device (CCD), or the like, and optically reads image data of the manuscript. Further, the image input unit 2 forms an optical image reflected from the manuscript set at a prescribed read position on the image sensor to output analog data of red-green-blue (RGB).

The image processing unit 3 generates, for example, digital type image data based on the analog data input from the image input unit 2 or reads the image data stored in the storage unit 7, performs processing depending on each type of images, and then generates image data to be output (printed). The image data for outputting generated by the image processing unit 3 is output to the image output unit 4.

The image output unit 4 prints an image on a recording medium such as recording paper, an OHP film, or the like based on the image data output from the image processing unit 3. The image output unit 4 includes a photosensitive drum, a charger for charging the photosensitive drum to a prescribed potential, a laser writing device which emits a laser beam depending on the image data received from an outside to generate an electrostatic latent image on the photosensitive drum, a developing device which supplies a toner to the electrostatic latent image formed on a surface of the photosensitive drum to develop the image, a transfer device which transfers a toner image formed on the surface of the photosensitive drum onto the recording medium, etc., and outputs the image on the recording medium by an electro-photographic method.

Further, the operation panel 5 is provided with hardware keys, such as functional keys for switching functions such as “facsimile,” “copy,” “printing,” “mail,” etc., in the multi-function peripheral 100, a sub power switch for receiving a starting/stopping instruction from a user, an enter key for fixing the received instruction, and a home key for returning a display screen of the display unit 6 to a home screen receiving a selection of any one of functions included in the multi-function peripheral 100 and the like.

The display unit 6 includes, for example, an LCD, an electroluminescence (EL) panel, or the like and displays an image to be output (printed) on the recording paper through the image output unit 4. Further, the display unit 6 displays a setting screen (so-called, a BIOS setting screen) for receiving an initial setting at the time of starting the multi-function peripheral 100.

The storage unit 7 includes, for example, a non-volatile storage medium such as a flash memory, an EEPROM, an HDD, a magneto-resistive memory (MRAM), a ferroelectric RAM (FeRAM), an OUM or the like.

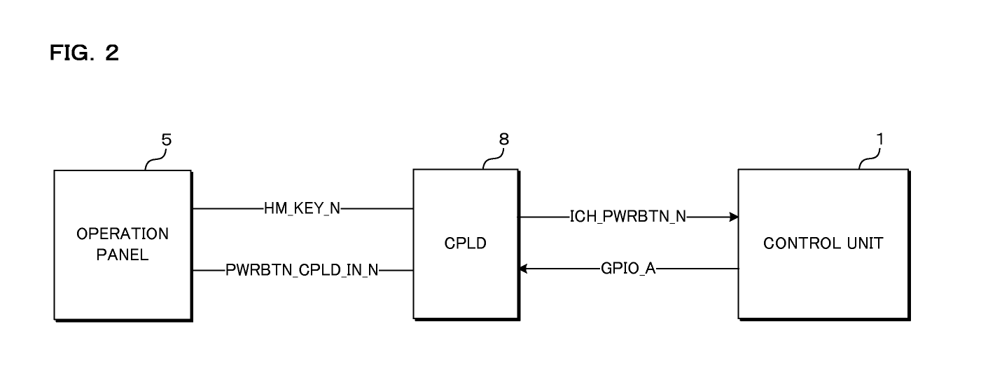

FIG. 2 is a block diagram describing a relation between the operation panel 5 and the control unit 1 in the multi-function peripheral 100 according to the embodiment of the present invention.

The operation panel 5 is connected with the control unit 1 through a complex programmable logic device (CPLD) 8. The CPLD 8 plays a role of the transfer unit described in the claims.

The CPLD 8 is a programmable logic unit which is an electrical circuit having a structure capable of being modified by programming, and is disposed between the operation panel 5 and the control unit 1.

The CPLD 8, in particular, when receiving a specific signal from the operation panel 5, transmits the fact thereof to the control unit 1 under a specific condition. Specifically, the CPLD 8 transmits an ICH_PWRBTN_N signal indicating the fact that the specific signal has been received from the operation panel 5 to the control unit 1 according to a permission signal, which is sent from the control unit 1 under the specific condition and will be described below.

For example, when the sub power switch included on the operation panel 5 is pressed by the user, a PWRBTN_CPLD_IN_N signal indicating the fact thereof is transmitted from the operation panel 5 to the CPLD 8. In the case in which the PWRBTN_CPLD_IN_N signal is received, only when the permission signal is received from the control unit 1, the CPLD 8 transmits the fact that the PWRBTN_CPLD_IN_N signal has been received to the control unit 1. That is, in the case in which the PWRBTN_CPLD_IN_N signal indicating the pressing of the sub power switch by the user is received, only when the permission signal is received from the control unit 1, the CPLD 8 transmits the ICH_PWRBTN_N signal indicating such a fact to the control unit 1.

Further, a HM_KEY_N signal indicating a operation of the home key included on the operation panel 5 is transmitted from the operation panel 5 to the CPLD 8, according to the operation of the home key by the user. In the case that the multi-function peripheral 100 is in a so-called standby mode, only when the PWRBTN_CPLD_IN_N signal indicating the pressing of the sub power switch by the user is received during receiving the HM_KEY_N signal, the CPLD 8 transmits the ICH_PWRBTN_N signal indicating such a fact to the control unit 1. In other words, in the case that the multi-function peripheral 100 is in the standby mode, only when the home key and the sub power switch are simultaneously pressed, the CPLD 8 transmits the ICH_PWRBTN_N signal indicating the pressing of the sub power switch by the user to the control unit 1.

Hereinafter, the PWRBTN_CPLD_IN_N signal indicating the pressing of the sub power switch by the user is referred to as “PWRBTN_CPLD_IN=0,” and the ICH_PWRBTN_N signal indicating the fact that the signal has been received is referred to as “ICH_PWRBTN=0.”

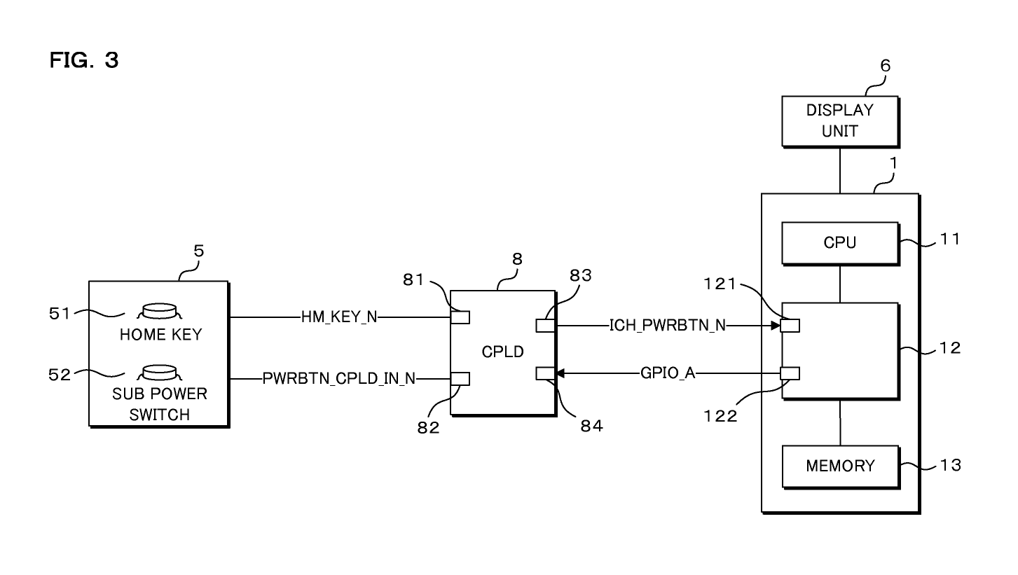

FIG. 3 is a diagram describing in detail the relation between the operation panel 5 and the control unit 1 in the multi-function peripheral 100 according to the embodiment of the present invention.

The control unit 1 includes a CPU 11, a southbridge 12 and a memory 13, and the CPU 11 transmits and receives the signal through the southbridge 12.

The southbridge 12 plays a role of a so-called “chip set” to control the passing of the signal in the control unit 1. In addition, the southbridge 12 receives the ICH_PWRBTN=0 signal from the CPLD 8 through an input terminal 121 to send it to the CPU 11, and transmits the permission signal to the CPLD 8 according to the instruction of the CPU 11.

As described above, only when the permission signal is received from the control unit 1, the CPLD 8 transmits the ICH_PWRBTN=0 signal to the control unit 1. That is, even if a sub power switch 52 is pressed by the user, when the permission signal is not transmitted from the control unit 1, the CPLD 8 does not transmit the ICH_PWRBTN=0 signal to the control unit 1. As seen above, the permission signal is a signal for permitting the transfer of the ICH_PWRBTN=0 signal to the CPLD 8, and the southbridge 12 sends the permission signal to the CPLD 8 through an output terminal 122 according to the instruction of the CPU 11. Hereinafter, the permission signal is referred to as a “GPIO_A signal,” a signal indicating that the transfer of the ICH_PWRBTN=0 signal by the CPLD 8 is permitted is referred to as a “GPIO_A=1,” and a signal indicating that the transfer thereof is not permitted is referred to as a “GPIO_A=0.”

The memory 13 is, for example, a SPI-Flash memory, and is stored with a BIOS relating to the multi-function peripheral 100. The CPU 11 performs initialization processing of each device at the time of starting the multi-function peripheral 100 using the BIOS stored in the memory 13.

The CPU 11 instructs the southbridge 12 so as to transmit the GPIO_A=1 signal to the CPLD 8 under a specific condition. The specific condition is, for example, a case of receiving the instruction displaying the setting screen for receiving the BIOS setting, until a first operation of the sub power switch 52 is performed after the main power switch S is turned on, or the like.

That is, in order to start the multi-function peripheral 100 when the main power switch S is turned on, it is necessary to receive the instruction through the sub power switch 52. Therefore, the CPU 11 instructs the southbridge 12 to output the GPIO_A=1 signal, until the sub power switch 52 is turned on after the main power switch S is turned on. Accordingly, at this time, the ICH_PWRBTN_N signal (ICH_PWRBTN=0 signal) from the CPLD 8 may be input to the southbridge 12 (CPU 11) through the input terminal 121.

Further, in order to cope with an inspection, an evaluation, or the like, in the manufacturing process of the multi-function peripheral 100, as well as maintenance, when the setting screen receiving the BIOS setting is displayed on the display unit 6 or an external display unit after the main power switch S is turned on, the CPU 11 instructs the southbridge 12 to output the GPIO_A=1 signal. Accordingly, at this time, the ICH_PWRBTN_N signal (ICH_PWRBTN=0 signal) from the CPLD 8 may be input to the southbridge 12 (CPU 11) through the input terminal 121.

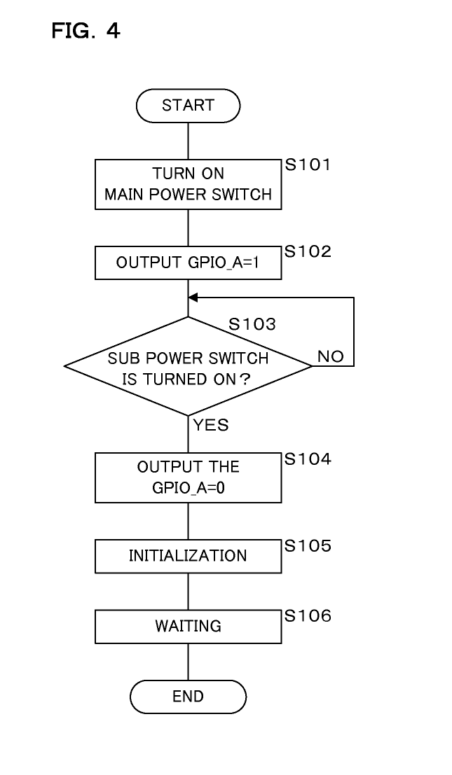

FIG. 4 is a flow chart illustrating an example of an instruction reception through the sub power switch 52 in the multi-function peripheral 100 according to the embodiment of the present invention. Hereinafter, for the convenience of explanation, the process until the first operation of the sub power switch 52 is performed after the main power switch S is turned on will be described by way of example.

A user who wishes to use the multi-function peripheral 100 according to the embodiment of the present invention presses the main power switch S to turn on the multi-function peripheral 100 (step S101). At this time, a PWRBTN_CPLD_IN=1 signal is output from the sub power switch 52.

In this regard, the CPU 11 instructs the southbridge 12 to output the GPIO_A=1 signal, and the southbridge 12 outputs the GPIO_A=1 signal through the output terminal 122 to the CPLD 8 (step S102).

At this time, for example, when the user presses the sub power switch 52, the PWRBTN_CPLD_IN=0 signal is transmitted to the CPLD 8 through an input terminal 82. The CPLD 8 receiving the signal transmits the ICH_PWRBTN_N signal indicating such a fact to the southbridge 12 through an output terminal 83.

The CPU 11 monitors the ICH_PWRBTN_N signal from the CPLD 8 through the southbridge 12 to determine whether the sub power switch 52 is pressed, that is, is turned on (step S103).

When it is determined that the sub power switch 52 is not turned on, that is, the sub power switch 52 is not pressed (NO in step S103), the CPU 11 repeats the determination until the sub power switch 52 is pressed.

On the other hand, when it is determined that the sub power switch 52 is turned on (YES in step S103), the CPU 11 instructs the southbridge 12 to output the GPIO_A=0 signal, and the southbridge 12 outputs the GPIO_A=0 signal to the CPLD 8 through the output terminal 122 (step S104).

At this time, the CPLD 8 receives the GPIO_A=0 signal through an input terminal 84. Thereafter, in the CPLD 8, even if the PWRBTN_CPLD_IN=0 signal is received from the sub power switch 52, the ICH_PWRBTN=0 signal is not transmitted to the southbridge 12. That is, even if the user presses the sub power switch 52 thereafter, it is regarded as invalid.

Accordingly, it is possible to prevent a failure of the sub power switch 52 due to an operation of the sub power switch 52 by a malicious user or the like.

Then, initialization such as a system check is performed (step S105), and when the initialization is ended, CPU 11 waits until receiving a prescribed instruction from the user (step S106).

Also in this case, since the southbridge 12 outputs the GPIO_A=0 signal to the CPLD 8 through the output terminal 122, a pressing of the sub power switch 52 by the user is invalid.

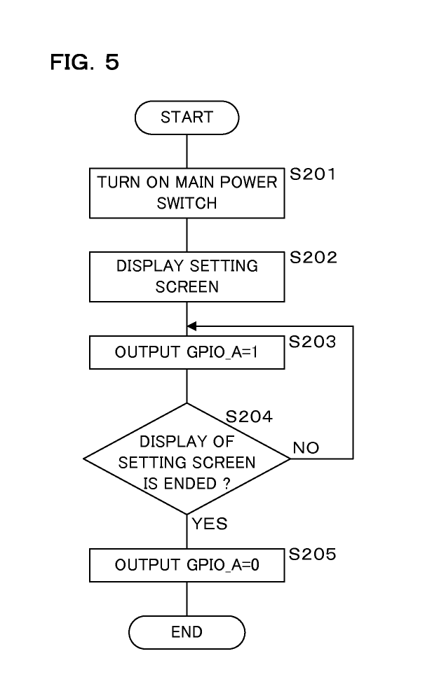

FIG. 5 is a flow chart illustrating another example of the instruction reception through the sub power switch 52 in the multi-function peripheral 100 according to the embodiment of the present invention. Hereinafter, for the convenience of explanation, a case of receiving the instruction displaying the setting screen for receiving the BIOS setting after the main power switch S is turned on will be described by way of example.

For example, when it is necessary to set the BIOS of the multi-function peripheral 100 in an incomplete state in the manufacturing process such as when the sub power switch 52 is not yet provided, a worker presses the main power switch S to turn on the power (step S201).

At this time, the worker operates the multi-function peripheral 100 through an interface (not illustrated) for example, and provides an instruction so as to display the setting screen for receiving the BIOS setting. For the convenience of explanation, in the present embodiment, a case of displaying the setting screen on the display unit 6 will be described by way of example.

When the instruction is received through the interface, the CPU 11 displays the setting screen on the display unit 6 based on the BIOS stored in the memory 13 (step S202).

In this regard, the CPU 11 instructs the southbridge 12 to output the GPIO_A=1 signal, and the southbridge 12 outputs the GPIO_A=1 signal to the CPLD 8 through the output terminal 122 (step S203).

Then, the CPU 11 monitors the interface to determine whether the instruction of a fact that the display of the setting screen is ended is received (step S204).

When it is determined that the fact that the display of the setting screen is ended is not received (NO in step S204), the CPU 11 returns the processing to S203, and instructs the southbridge 12 to output the GPIO_A=1 signal. The above described processing is performed until the CPU 11 receives the instruction of the fact that the display of the setting screen is ended.

When it is determined that the fact that the display of the setting screen is ended is received (YES in step S204), the CPU 11 instructs the southbridge 12 to output the GPIO_A=0 signal, and the southbridge 12 outputs the GPIO_A=0 signal to the CPLD 8 through the output terminal 122 (step S205).

Thereafter, since the southbridge 12 continuously outputs the GPIO_A=0 signal to the CPLD 8 through the output terminal 122, the pressing of the sub power switch 52 by the user is invalid. Accordingly, it is possible to start of the multi-function peripheral 100 at the time of the inspection and evaluation in the manufacturing process while limiting the operation of sub power switch 52.

In addition, as a method of preventing an occurrence of the failure due to an operation of the sub power switch 52 by the malicious user, the multi-function peripheral 100 according to the embodiment of the present invention has a configuration in which, when the multi-function peripheral 100 is in a so-called standby mode, the pressing of the sub power switch 52 is valid only when any hardware key provided on the operation panel 5 is simultaneously pressed therewith.

For example, when the user presses the sub power switch 52, and the PWRBTN_CPLD_IN_N (PWRBTN_CPLD_IN=0) signal indicating the pressing of the sub power switch 52 is received by the input terminal 82 of the CPLD 8, the CPLD 8 monitors an input terminal 81 to determine whether a HM_KEY_N signal (hereinafter referred to as HM_KEY=0) indicating the fact that any hardware key (for example, a home key 51) of the operation panel 5 is pressed is transmitted to the input terminal 81.

When the HM_KEY=0 signal is received, the CPLD 8 outputs the ICH_PWRBTN=0 signal indicating the fact that the PWRBTN_CPLD_IN=0 signal has been received due to the pressing of the sub power switch 52 by the user to the southbridge 12 through the output terminal 83.

On the other hand, when the HM_KEY=1 signal is received, the CPLD 8 invalidates the PWRBTN_CPLD_IN=0 signal received through the input terminal 82.

In accordance with the multi-function peripheral 100 according to the embodiment of the present invention having the above-described configuration, it is possible to prevent the failure due to a mischief by the user, or a violent operation of the sub power switch 52 by the malicious person.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-4. (canceled)

5. An electric device including a main power switch connected to a regular power supply, a sub power switch which receives a starting/stopping instruction from a user when the main power switch is turned on, and a control unit which acquires a notification signal notifying a fact that the instruction has been received from the sub power switch and controls the starting/stopping based on the notification signal, the electric device comprising:
a transfer unit which is disposed between the sub power switch and the control unit, and is configured, when the notification signal is received from the sub power switch, to transfer a fact of reception of the notification signal to the control unit,
wherein the control unit transmits a permission signal of a fact that the transfer by the transfer unit is permitted to the transfer unit, and
when receiving the permission signal, the transfer unit transfers the fact of reception of the notification signal to the control unit.

6. The electric device according to claim 5, wherein, when the main power switch is turned on, the control unit is configured to transmit the permission signal to the transfer unit until the sub power switch is turned on.

7. The electric device according to claim 5, comprising a display control unit which displays a setting screen for receiving an instruction relating to an initial setting at start up,
wherein the control unit is configured to transmit the permission signal to the transfer unit while the setting screen is displayed.

8. The electric device according to claim 5, comprising an instruction reception unit which receives an instruction for performing functions of the electric device,
wherein, the transfer unit is configured, when the instruction reception unit receives the instruction and the sub power switch receives the starting/stopping instruction from a user, to transfer the fact of reception of the notification signal to the control unit.
